(19) United States
(12) Patent Application Publication
(10) Pub. No.: US 2012/0012299 A1
(43) Pub. Date: Jan. 19, 2012

(54) Proportional Micro-Valve With Thermal Feedback

(75) Inventor: Randall N. Avery, Bogart, GA (US)

(73) Assignee: Industrial Idea Partners, Inc.

(21) Appl. No.: 12/838,351

(22) Filed: Jul. 16, 2010

(51) Int. Cl. G05D 23/00

(52) U.S. Cl. 165/287

(57) ABSTRACT

A proportional micro-valve for regulating the temperature of an electronic component comprising a cooling subsystem associated with each thermal zone of the electronic component, a cooling circuit carries cooling fluid to a heat exchanger associated with each thermal zone, the flow of which is controlled by a valve element, which is in turn controlled by a sensing circuit which reacts to the temperature of the underlying thermal zone to proportionally increase or decrease the rate of cooling fluid flowing through the heat exchanger based upon the temperature of the thermal zone. Cooling fluid substantially continuously flows through the sensing circuit, regardless of whether the valve element is open or closed. The sensing circuit provides feedback to a temperature-responsive mechanical amplifier for opening and closing the valve element.

### CROSS-REFERENCE TO RELATED APPLICATION

This application contains subject matter which is related to the subject matter of U.S. patent application Ser. No. 12/751,916 entitled “Liquid-Based Cooling System For Data Centers Having Multi-Sensor Proportional Flow Control Device,” by Avery, which is assigned to the same assignee and which is incorporated herein by reference in its entirety, and which in turn is related to U.S. patent application Ser. No. 12/606,895 entitled “Utilization of Data Center Waste Heat for Heat Driven Engine,” by Avery, et al., which is assigned to the same assignee and which is also incorporated herein by reference in its entirety.

### BACKGROUND OF THE INVENTION

This invention relates generally to increasing the efficiency of energy utilization of computer data centers. Specifically, this invention relates to a method of removing the waste heat generated by individual electronic components (chips) found in computers by using only the amount of cooling required to cool each electronic component to a desired temperature. A liquid cooling means is described to remove the heat from the equipment and expel it directly from the data center rather than simply dispelling it to the surrounding air. Dispelling the heat to the surrounding air does not remove the heat from the data center. This final removal of heat dispelled to the data center is often left to additional and energy inefficient processes. The present invention is usable as part of a cooling system that carries data center waste heat out of the data center.

Further, this invention relates to the use of the heat from individual, fully operational, electronic components to maintain the temperature of selected inactive electronic components, minimizing the temperature excursions of the inactive equipment, keeping it in a ‘ready to run’ thermal condition and improving its lifespan. This is accomplished by removing the waste heat from the operational equipment and delivering it to other heat-generating equipment that is currently inactive by using liquid cooling heat transfer elements mounted on each of the electronic components.

A data center, sometimes called a server farm, is a facility used to house computer systems and associated components, such as telecommunications and storage systems. It may be an entire building, a single room, or one or more floors or other separate portions of a building. In addition to computer systems and associated components, data centers typically house one or more redundant backup power supplies, redundant data communications connections, environmental controls (e.g., air conditioning systems, fire suppression systems) and security devices.

Adequate environmental controls are a priority for data centers because such systems must continually provide environmental conditions suitable for the computer and server equipment used to store and manipulate a business' electronic data and information systems. For example, the American Society of Heating, Refrigerating and Air-Conditioning Engineers, Inc., in its “2008 AHSRAE Environmental Guidelines for Datacom Equipment,” recommends that data centers have an environmental temperature range of 20-25° C. (68-75° F.) and a relative humidity range of 40-55%.

As the amount of equipment in a data center increases, and as the number of computations or operations per component increase and the speed of individual components increase, the computers and other electronic components will generate increasing amounts of waste heat. Growth in the size, complexity and sophistication of data centers and the components housed therein have required correspondingly larger and more powerful air cooling and dehumidification systems to keep the data center and the equipment it houses sufficiently cool. Keeping an area and the devices within it cool yet at a uniform or baseline operationally optimal temperature can also be conceptualized as rejecting the heat generated by the hottest equipment and redistributing it internally or externally within the data center.

There are over 60,000 data centers in the U.S. and Canada. Data centers consume approximately 1.7% of the U.S.'s electricity (costing about U.S. $5B per year). Large data centers can consume up to 30-40 MW in energy each year, 10 MW or more of which goes to cooling. U.S. data centers consumed 66 million MW-Hrs of electricity in 2007, and this number is growing at 12% per year (doubling every 5 years), with at least one third of this going to cooling. The present invention provides a novel method of reducing the energy demands of this cooling load and putting heat energy previously rejected as waste to use.

Pending U.S. patent application Ser. No. 12/038,894 entitled “Variable Flow Computer Cooling System For A Data Center And Method Of Operation,” by Hoffberg, teaches that computer equipment or chips may have thermal zones that have higher temperatures than other zones and these zones move about the surface of the computer equipment based upon the usage and general load being applied to the specific equipment. This understanding makes it useful to create a cooling system that can adapt to and accommodate the changing nature of the thermal load on the equipment. Ser. No. 12/038,894 suggests a complex method of responding to this changing thermal load pattern. The present invention describes a much simpler and mechanically self-regulating means of adjusting the cooling to the thermal patterns of the equipment. The present invention has the advantage that it does not itself create more computing requirements or an increase in the total thermal load by itself requiring additional processing of instructions or requiring additional electricity to provide heating or power for controlling valves.

U.S. Pat. No. 7,367,359 entitled “Proportional Micromechanical Valve,” issued to Nguyen, the disclosure of which is incorporated herein by reference, teaches a means of building a micro-valve that can be adjusted proportionally to the desired fluid flow. It uses an external electronic circuit to measure the desired response of the proportional valve and to electrically heat and thereby adjust thermal actuators for the actuation of the micro-valve. This design can provide a quick and powerful response but requires a considerable amount of external computing and electrical power to provide the response. The present invention provides a suitable response to the needs of the underlying electronic component without requiring the application of external electrical power.

### BRIEF SUMMARY OF THE INVENTION

The present invention relates to the use of a proportional micro-valve mounted on and responding to the heat generating computer chips such as the CPU chips and video drivers on the circuit boards of computers. The proportional micro-valve of the present invention provides an amount or flow of cooling liquid proportional to the amount of heat to be extracted by a liquid cooled heat exchanger mounted on the computer chip. The amount of cooling is proportional to the temperature rise that the chip achieves and is sufficient cooling to extract the amount of heat that the chip is producing at a predetermined temperature and temperature rise across the heat exchanger. A proportional valve utilizes the laws of fluid pressure to distribute input forces to one or more output lines. A proportional valve can increase or decrease the force of each output line depending upon the cross-sectional surface areas of the output line.

It is understood that different uses and different architectures of computer chips result in different patterns of power being consumed in different portions of the computer chips and that these different power patterns result in different temperature patterns on the surface of the computer chip where the heat must be dissipated. It is also well understood within the industry that maintaining a constant and uniform temperature on the heat transfer surface of the computer chip, and therefore of the computer chip itself, will maximize the performance and extend the life of the computer chip. Achieving such a constant and uniform temperature profile requires that, at certain times, heat may need to be added to individual portions of chips and cooling be added to some portions of computer chips. The proportional micro-valve is designed to provide this constant and uniform temperature of the chips by providing heating or cooling to the chip as necessary.

Presently, computer chips are often cooled with air moving across a large finned heat exchanger mounted on the chip by using one or more fans to drive the air flow. Considerable effort is made to duct and direct the air flow to the computer chips that need the cooling based upon an expected heat profile. The speed of the fans in the latest designs is controlled by an electrical feedback process that monitors the temperature of the computer chip itself and provides a proportional amount of power to individual fans. As the computer chip heats up, the fans will increase in speed, power consumption and thereby their cooling effect. In some server architectures, this process of controlling the amount of cooling by varying the speed of individual fans has resulted in the need for an additional computer chip and considerable software dedicated to this particular process.

An air cooled heat exchanger mounted on the computer chip essentially covers the entire computer chip with one homogeneous device that responds to the cooling air flow with relatively uniform cooling applied to the entire surface of the computer chip. This uniform amount of cooling from the heat exchanger results in some portions of the computer chip being overcooled and some portions of the computer chip being undercooled. The heat exchanger is not designed to match the power or heat pattern of the computer chip with cooling dedicated to the individual portions or areas of the computer chip that need cooling.

The cooling of a computer chip is provided by applying a cooling means, air or liquid, to the surface of the computer chip that is cooler than the surface. The larger the difference between the temperature of the cooling means and the temperature of the computer chip surface, the larger the amount of heat that can be extracted from the surface. Therefore it is desirable to allow the computer chip to warm substantially before applying any cooling to save some of the power dedicated to fans. This practice, however, results in the extension of the duration of the temperature excursion of the computer chips, forcing them to endure a greater temperature increase over a longer period of time before the application of a cooling means.

Countering this need to increase the temperature at which the fans are initiated is the relatively inefficient thermal transfer provided by moving air. Air simply cannot dispel much heat because of its physical characteristics. Liquid cooling is much more efficient and will require a smaller temperature differential across the heat exchanger to extract the same amount of heat from the chip surface. Liquid cooling can also be applied more discreetly on the regions of larger chips that need cooling but typically comes with a higher manufacturing cost and more risk of damage of the computer components if the liquid is allowed to leak. The higher cost and risk of the liquid cooling has discouraged manufacturers from applying this method of cooling in the past. As the power densities of computer chips increase year after year and model after model, the need to switch to the more efficient liquid based heat exchanger increases. Eventually, the logic of gaining the advantage of the higher efficiency of liquid driven heat exchangers becomes overwhelming in order to limit the higher temperature, heat flow and the need for more uniform temperature distribution of the latest designs.

It is also well understood in the industry that a constant and uniform chip temperature will provide the longest life for the chip. A constant temperature avoids the mechanical stresses that thermal expansion from temperature excursions create. Air cooled heat exchangers are not designed to create and maintain an equilibrium temperature between warm and cold computer chips in the individual computer servers. This unbalanced condition allows the entire server to cool and the hot CPU chips to cool the most. In contrast, the proportional micro-valve of the present invention will circulate a small amount of the cooling fluid through inactive chips primarily to sense when the computer chips are in use and demand cooling. However, a secondary effect of this cooling fluid circulation is to keep these chips at a temperature that is above the ambient air temperature providing that some portion of the data center is in use and warming the cooling fluid to its minimum temperature. This will limit the temperature excursion that all of the hot chips will experience and will improve the chip life. This elevated temperature compared to ambient will also reduce the possibility for condensation.

It is also understood by those in the industry that it is desirable to respond to these different and varying temperature patterns with different quantities of cooling to different segments or zones of the hot surface of the computer chip in order to provide a resulting temperature that is uniform in space and in time. The proportional micro-valve with thermal feedback described in the present invention can be subdivided and segmented into a wide variety of patterns or zones in order to correlate to the individual thermal patterns that the underlying computer chip creates. The proportional micro-valve is completely self-contained with its own thermal feedback capability so it can be applied in a seemingly endless string of patterns. Only two exemplary patterns will be described in this disclosure, but it is understood that many different patterns can be created and applied.

It is further understood that the designers of the computer chips can describe the thermal patterns of the computer chips in terms of functional zones or geography based upon the architecture and usage of the computer chip. These geographic zones of the computer chips become the thermal zones that change in temperature with time based upon the usage of the chip. It will be the anticipated variety of these thermal zones that will dictate the subdivision of the proportional micro-valve with thermal feedback. The flexibility in design and manufacturing of the proportional micro-valve of the present invention will accommodate thermal zone designs of almost any shape.

The heat exchanger of the proportional micro-valve with thermal feedback that is mounted upon the chip should be capable of sufficient thermal translation and reaction to the resulting temperature patterns and changes across the different geography of the heat extraction surface of the computer chip. The proportional micro-valve described herein is capable of being segmented into different cooling zones or cooling subsystems that can supply the heat exchanger elements of the proportional micro-valve with different quantities of cooling fluid based upon the activity in the chip and the ensuing heat generation. The design and segmenting of the fluid distribution circuits and the valve elements may be customized during manufacturing to the thermal requirements of each of the thermal zones.

### BRIEF DESCRIPTION OF THE DRAWINGS

The particular features and advantages of the invention as well as other objects will become apparent from the following description taken in connection with the accompanying drawings in which:

FIG. 1 is an exploded perspective view of a proportional micro-valve illustrating one embodiment of a proportional micro-valve having six (6) thermal zones.

FIG. 2 is a top view of a single heat exchanger element of a heat exchanger layer.

FIG. 3a is a top view of a portion of one embodiment of a valve element according to the present invention.

FIG. 3b is a top view of a portion of another embodiment of a valve element according to the present invention.

FIG. 3c is a top view of the single valve element of FIG. 3a illustrating the flow of cooling fluid through the valve vanes.

FIG. 4 is a top view of a portion of a cooling fluid distribution layer.

FIG. 5 is a schematic representation of an example thermal map of the top of an electronic component.

FIG. 6 is a top view of a first intermediate layer according to the present invention illustrating how the divisions of the first intermediate layer may be structured to correspond with the thermal zone patterns of an electronic component.

FIG. 7 is a top view of a heat exchanger layer of the present invention illustrating how the heat exchanger elements of the heat exchanger layer may be structured to correspond with the thermal zone patterns of an electronic component.

FIG. 8 is a top view of a second intermediate layer according to the present invention illustrating how the divisions of the second intermediate layer may be structured to correspond with the thermal zone patterns of an electronic component.

FIG. 9 is a top view of a valve layer and valve elements according to the present invention illustrating how the valve elements may be structured to correspond with the thermal zone patterns of an electronic component.

FIG. 10 is a top view of a fluid distribution layer according to the present invention illustrating how the divisions of the fluid distribution layer may be structured to correspond with the thermal zone patterns of an electronic component.

### DETAILED DESCRIPTION OF THE INVENTION

Data centers and the multiplicity of types of data center equipment and electronic components located therein are well known in the art. It is also well known that electronic components within a data center generate a significant amount of heat that must be controlled by various means to maintain the data center equipment in working order. While it is not practical to include an exhaustive list of the function and type of every potential type of equipment that might be found in a data center of a business or other organization, for purposes of this disclosure, the term “electronic component” will be used to refer to any type of heat-generating component that one may find useful to locate within a protected environment of an organization's data center or other facility for the collection and installation of computer systems, electronics or controls. Such electronic components typically comprise, but are not limited to, computer systems, electronics, data storage systems, communications equipment, networking equipment, information technology equipment and components and parts therefore, such as, but not limited to electronic components such as servers, chips, processors, motherboards, sound cards, graphics cards, memory devices, data storage devices, modems, and any other equipment or component that now or may in the future be found useful in the field. Further, the term “electronic component” will be used to refer to that subset of the equipment that would benefit from externally applied fluid cooling apparatus to limit the component's temperature excursions, its temperature and its temperature rise from the internally generated heat created during its operation. By way of example, an electronic component may comprise one or more integrated circuit chips and/or other electronic devices to be cooled, including one or more processor chips, memory chips and memory support chips.

The benefits of use of the present invention are primarily the achievement of a stable temperature for the electronic component and a uniform temperature pattern maintained by responsive cooling apparatus that is proportional and physically segmented to provide a response that is customized to the architecture and use of individual electronic component.

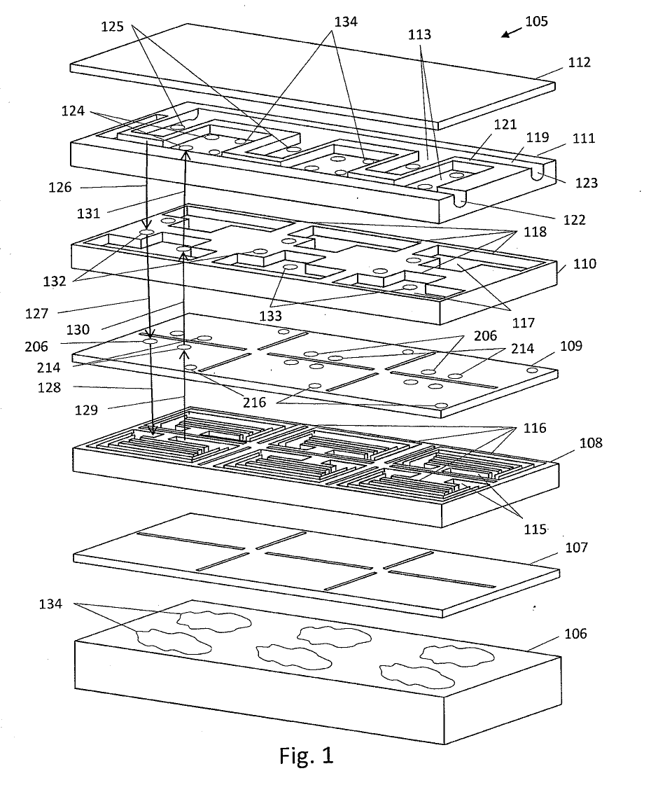

FIG. 1 illustrates a perspective view of the fluid cooling apparatus comprising one embodiment of the proportional micro-valve with thermal feedback 105. The proportional micro-valve with thermal feedback 105, hereinafter referred to as a micro-valve, will be thermally in contact with an electronic component 106, here a computer chip. The micro-valve comprises a heat exchanger layer 108 in thermal contact with the electronic component 106, a valve layer 110 for controlling the flow of coolant fluid to the heat exchanger layer 108, and a fluid distribution layer 111 for supplying coolant fluid to the valve layer 110. Heat exchanger layer 108, valve layer 110 and fluid distribution layer 111 may each be structured with integral separation, such as floor 113 of fluid distribution layer 111, to prevent unwanted fluid communication from layer to layer. However, for ease of manufacturing, it is preferable to incorporate substantially solid dividing layers such as thermally conductive first intermediate layer 107, second intermediate layer 109 and a cap layer 112. The use of a third intermediate layer (not shown) between the valve layer 110 and the fluid distribution layer 111 is also within the contemplation of this invention. All of the layers 107, 108, 109, 110, 111, 112 of the micro-valve 105 are preferably made of substantially the same material so that each will have substantially the same coefficient of thermal expansion. Suitable materials for the layers are known in the art, including, but not limited to, silicon or other semiconductor materials, such as glass, conductive ceramic, steel, aluminum, any other metallic or conductive materials or combinations of materials such as bimetallic materials.

The heat exchanger layer 108 in this embodiment of the micro-valve 105 comprises a liquid cooling means, such as fluid heat exchanger elements 116, and a fluid sensing circuit for providing feedback to the valve element 118 of micro-valve 105. Further, in the embodiment of FIG. 1, the heat exchanger layer 108 is segmented or subdivided into a plurality of heat exchanger elements 116, each heat exchanger element 116 structured to correspond with a corresponding thermal zone 134 of the electronic component 106. Each of the plurality of heat exchanger elements 116 are in close thermal contact with a corresponding thermal zone 134 in the underlying electronic component 106. The number, size and shape of the plurality of heat exchanger elements 116 may be structured to substantially match the number, size and shape of the corresponding thermal zones 134 of the electronic component 106 that are disposed below the heat exchanger layer 108.

The heat exchanger layer 108 in this embodiment of the micro-valve 105 is separated from the computer chip 106 by a thermally conductive first intermediate layer 107 that provides the manufacturing convenience of sealing or closing the underside of the physical fluid openings 115 of each heat exchanger element 116 and containing the cooling fluid within each of the heat exchanger elements 116.

The valve layer 110 is also segmented into a plurality of valve elements 118 that correspond in number, size and shape to the associated heat exchanger elements 116 of the heat exchanger layer 108. The valve layer 110 of the micro-valve 105 is separated from the heat exchanger layer 108 by a second intermediate layer 109 that provides the manufacturing convenience of separating the fluid openings 117 in the valve elements 118 of the valve layer 110 from the fluid openings 115 of the heat exchanger elements 116 of the heat exchanger layer 108.

Above the valve layer 110 is a fluid distribution layer 111 configured to deliver cooling fluid to each of the underlying valve elements 118 of the valve layer 110 and, depending on the open or closed condition of the valve elements 118, onward to the individual heat exchanger elements 116 of the heat exchanger layer 108.

In an alternate embodiment not shown in FIG. 1, the fluid distribution layer 111 may be separated from the valve layer 110 by a third intermediate layer. In the embodiment shown in FIG. 1, this third intermediate layer is not shown and is replaced by a fluid distribution layer 111 that is comprised of fluid channels 119 that are enclosed on the lower surface or floor 113 of the fluid distribution layer 111. The manufacturing of the fluid channels 119 of the fluid distribution layer 111 in this enclosed manner eliminates the need for a third intermediate layer. Fluid channels 119 have a plurality of openings 124, 125, 134 positioned as necessary to allow fluid communication with the valve layer 110.

The micro-valve 105 further comprises a fourth intermediate layer, or cap, 112 to close the upper surface 121 of the fluid distribution layer 111 and define one or more fully enclosed fluid entry channels 123 and one or more fully enclosed fluid exit channels 122.

In the embodiment shown in FIG. 1, the micro-valve 105 is subdivided into six (6) cooling subsystems to correspond with the thermal zones 134 of the associated electronic component 106. However, other configurations of the micro-valve 105 of the present invention that are subdivided into one or more cooling subsystems are within the contemplation of this invention. The precise configuration and shape of cooling subsystems of a micro-valve 105 will be determined based upon the thermal zones of the associated electronic component 106. The electronic component 106 illustrated in FIG. 1 has six (6) thermal zones 134, so, preferably, cooling is provided by association with a micro-valve 105 having one or more, in this case six (6), corresponding cooling subsystems, each cooling subsystem comprising a heat exchanger element 116 in the heat exchanger layer 108, a corresponding valve element 118 in the valve layer 110, a corresponding fluid entry port 125 within the fluid distribution layer 111, a corresponding fluid exit port 124 within the fluid distribution layer 111, and a corresponding valve port 132 within the valve layer 110. In other words, a micro-valve 105 for a particular electronic component 106 comprises one or more cooling subsystems, each cooling subsystem corresponding to and associated with a thermal zone 134 of the electronic component 106.

Cooling fluid directed into the micro-valve 105 is directed from the fluid distribution layer 111 to the valve elements 118 of the valve layer 110 through fluid entry ports 125. When the valve is open, the fluid flows in the direction of the flow arrow 126 between these layers 111, 110. The fluid continues to flow to the underlying heat exchanger elements 116 via the valve ports 132.

The cooling fluid flows from the open valve ports 132 through corresponding fluid entry ports 206 defined within the second intermediate layer 109 to the heat exchanger elements 116 of the heat exchanger layer 108 as illustrated by flow arrows 127 and 128.

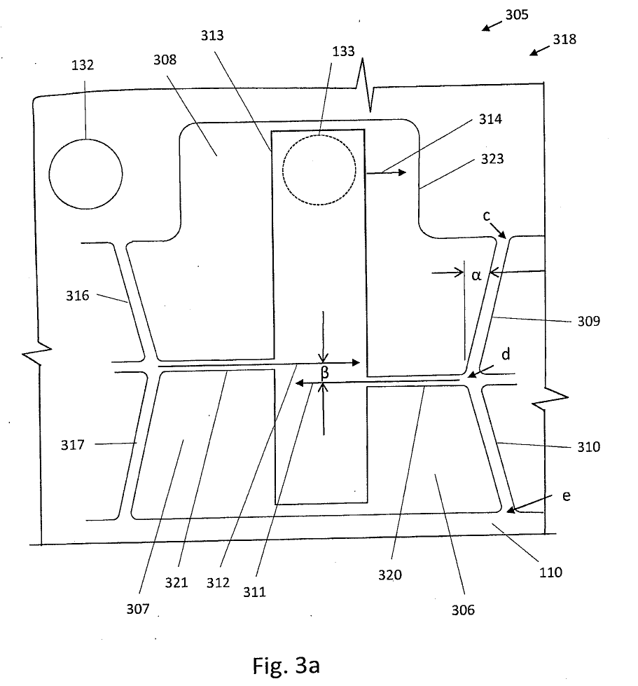

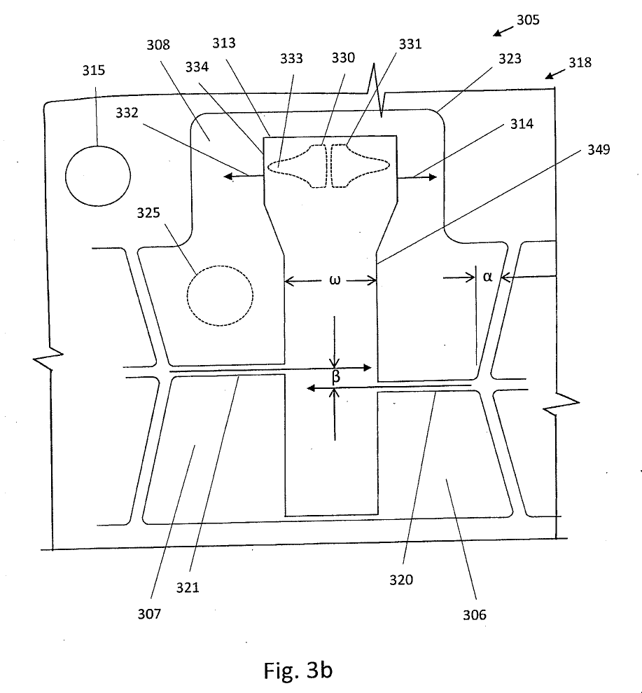

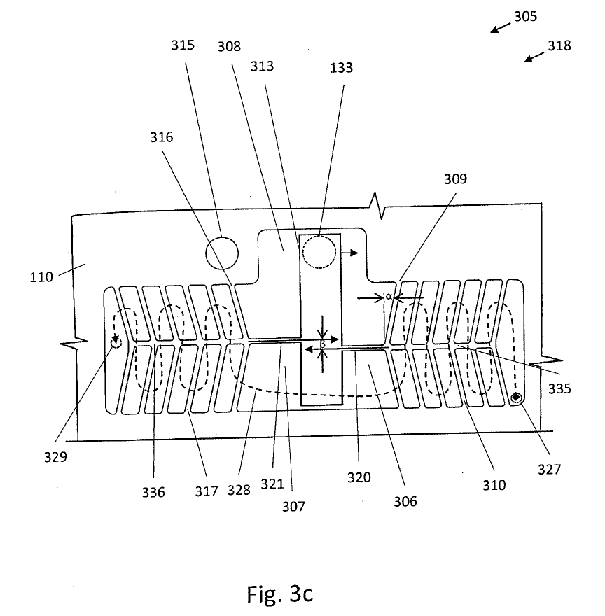

The cooling fluid then circulates through the heat exchanger elements 116 in the heat exchanger layer 108 and returns in a generally upward direction along the flow arrow 129 and through the fluid exit ports 214 of second intermediate layer 109. If the valve is open, the fluid continues in a generally upward direction along the flow arrow 130 from the second intermediate layer 109 into the valve layer 110 (the fluid exit port 214 is shown for illustration purposes only in FIG. 1 as valve entry ports 133). The fluid exit ports 214 (a.k.a. valve entry ports 133) are opened and closed by the mechanism of the valve elements 118 as described in more detail in connection with FIGS. 3a-3c, thereby controlling the cooling fluid flow proportionally in accordance with the need for cooling of the associated thermal zone 134.

The fluid passing through the valve elements 118 will be returned to the fluid distribution layer 111 along flow arrow 131 through the fluid exit ports 124 defined within the distribution layer 111.

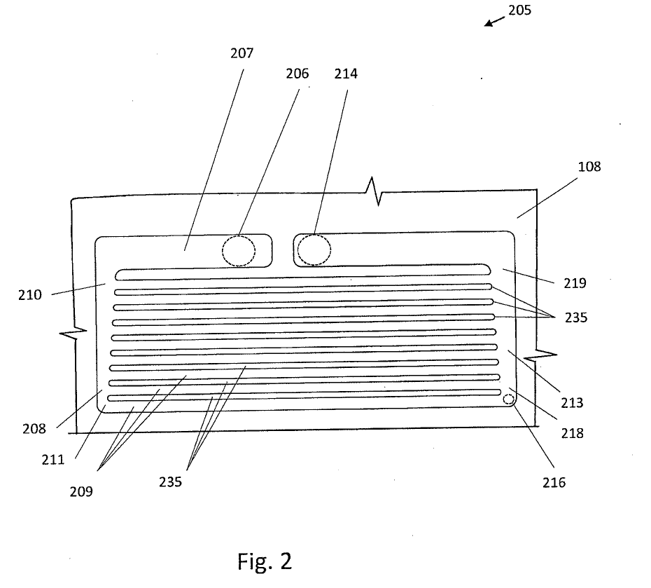

FIG. 2 illustrates one heat exchanger element 205 of the heat exchanger layer 108. Cooling fluid enters the heat exchanger element 205 from the valve layer 110 via the fluid entry port 206 of the second intermediate layer 109 (not shown). The cooling fluid fills the fluid entrance header 207 and moves to the entry channel header 208 at the start of the main cooling channels 209. In the embodiment of FIG. 2, the width of the entry channel header 208 is tapered from being widest proximate the entrance header beginning 210 to being the most narrow proximate the entrance header end 211 in order to maintain a substantially uniform pressure and flow rate of cooling fluid through each of the main cooling channels 209.

Main channel walls 235 serve as thermal fins aiding in the transfer of heat from the underlying electronic component 106 (not shown in FIG. 2) to the cooling fluid circulating in the heat exchanger element 205.

The cooling fluid exits the main cooling channels 209 and enters the exit channel header 213 which, symmetrically mirroring the entry channel header 208, is tapered from narrowest proximate the exit channel beginning 218 to widest proximate the exit channel end 219 in order to produce substantially even pressure distribution and flow rates of cooling fluid through the main cooling channels 209 into the exit channel header 213. When the valve is open, a first portion of the cooling fluid leaves the exit channel header 213 and heat exchanger element 205 through the fluid exit port 214 of the above second intermediate layer 109.

Substantially continuously, regardless of whether the associated valve element (not shown) is in the open or closed condition, a second portion of cooling fluid flows through a sensing circuit of the cooling subsystem. In the sensing circuit, a portion of the cooling fluid that enters the heat exchanger element 205 through the fluid entry port 206, flows along the fluid entrance header 207, traverses entry channel header 208 and the main cooling channels 209, and exits the heat exchange element 205 through a sensing exit port 216 defined within the second intermediate layer 109 that allows a comparatively smaller amount of cooling fluid to enter the sensing zones 306, 307 (shown in FIG. 3a) of the valve layer 110. This relatively smaller second portion of cooling fluid traverses the sensing zones 306, 307 and is returned to the fluid distribution layer 111 to complete the sensing circuit or feedback loop which, as explained herein, controls the opening and closing of the valve element 118.

When the main flow of cooling fluid is prevented from circulating through the heat exchanger element 205 because the valve element 118 in the valve layer 110 is closed, this relatively small, second portion of cooling fluid in continuous circulation through the sensing circuit adopts the temperature of the underlying electronic component 106 as it traverses the main cooling channels 209 and provides feedback to the mechanical amplifier of the valve element 118 (as described in connection with FIG. 3a).

This thermal feedback is present at all times between the heat exchanger element 205 and the valve elements 118 of the valve layer 110. As discussed below, the constant flow of cooling fluid through the feedback loop provides the means for the valve elements 118 to open, to close and to adjust the flow of the majority of the cooling fluid through the associated heat exchanger element 205 independently of the valve positions of adjacent heat exchanger elements 205.

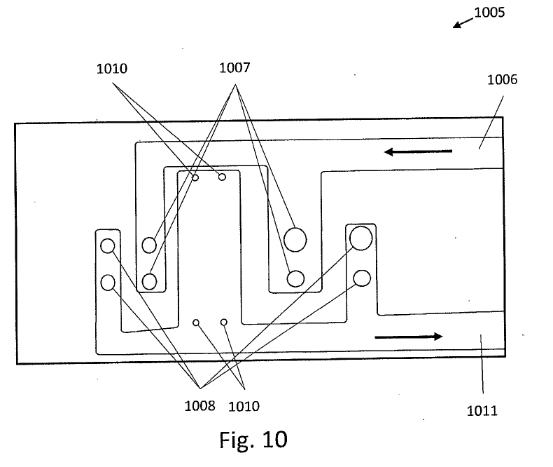

In practice, the main cooling channels 209 may be manufactured by cutting entirely through the heat exchanger layer 108. As shown in FIG. 1, this will require the addition of the first intermediate layer 107 and second intermediate layer 109 in the assembly of the micro-valve 105. In the embodiment illustrated in FIG. 2, the openings identified as fluid entry port 206, fluid exit port 214 and sensing exit port 216, will actually comprise openings defined within the second intermediate layer 109 rather than being physically defined as part of the structure of the heat exchanger layer 108. These ports, 206, 214 and 216, may be positioned about the heat exchanger layer 108 as illustrated in FIG. 2 relative the rest of the heat exchanger element 205, though alternate configurations and cooling fluid flow patterns for the heat exchanger element 205 are within the contemplation of this invention. This will be illustrated more fully in the discussion of FIG. 10.

FIG. 3a illustrates a portion of a valve element 305 from the valve layer 110. Valve elements 305 according to the present invention is movable from a closed position through a multiplicity of partially open conditions to a fully open condition, thereby regulating the flow of cooling fluid through the valve element 305 in proportion to the condition of the valve element 305. A valve element 305 is defined within the valve layer 110 and comprises a first thermal sensing zone 306 in fluid connection with a second thermal sensing zone 307, a separate valve control zone 308, a valve control arm 313 integral to and of the same material as the valve layer 110, and a plurality of vanes 309, 310, 316, 317. The thermal sensing zones 306, 307 of the valve element 305 further comprise a plurality of thermal expansion vanes integral to and of the same material as the valve layer 110, as illustrated by a first vane 309, a second vane 310, a third vane 316 and a fourth vane 317 that respond to the temperature of the cooling fluid entering the valve element 305 from the heat exchanger layer 108 through the second intermediate layer 109. In one potential embodiment, these thermal expansion vanes 309, 310, 316, 317 are constructed from a silicon material that has a non-uniform, primarily lengthwise response to increases in temperature, each vane configured to expand proportionally along its length to a greater amount than it expands in thickness or width. The silicon is oriented so that the length of the first vane 309 from point c to point d incurs the greatest amount of expansion in a direction towards the push bar 320 in response to a temperature increase of the vane. The thermal expansion and increase in length creates a force that pushes on the intersection at point d. Second vane 310 is similarly oriented so that its greatest expansion occurs from point e to point d, thereby creating a similar force pushing in the generally opposite direction as vane 309. These opposing forces cause the forces to be translated to a horizontal force on the horizontal push bar 320, moving it laterally to the left in FIG. 3a and in the direction of arrow 311. The angle α between the vanes 309, 310 and the push bar 320 determines the characteristics and the amount of the motion of the push bar 320 in response to temperature changes. A smaller angle α creates a larger displacement of the push bar 320 in the direction of arrow 311.

A similar but opposing force and push from the opposite direction of the forces on push bar 320 is being created from the second set of vanes 316, 317 and push bar 321 in the second thermal sensing zone 307. This opposing force is occurring along a second horizontal push bar 321 along the directional arrow 312.

The points at which first opposing push bar 320 and the second opposing push bar 321 are connected to, and preferably integral with, valve control arm 313 are offset in a horizontal displacement identified as width β. The horizontal displacement β between opposing push bars 320, 321 creates a twisting force on the valve control arm 313, causing it to move in the direction of arrow 314 as the temperature of the cooling fluid increases. As the valve control arm 313 moves in the direction of arrow 314, it opens or uncovers all or a portion of valve entry port 133 (which is shown in FIG. 3a as a representation of the fluid exit port 214 of second intermediate layer 109 (fluid exit port 124 of the fluid distribution layer 111 is directly above fluid exit port 214, but not numbered in FIG. 3a)). The opening of valve entry port 133 allows cooling fluid to circulate through a continuous cooling circuit from the fluid distribution layer 111, through cooling fluid port 132 of the valve element 305 to the heat exchanger element 205, from the heat exchanger element 205 through the valve entry port 133 to the valve element 305, and from the valve element 305 through the fluid exit port 124 (not shown) to the fluid distribution layer 111.

The amount of force along the first push bar 320 and the second push bar 321 is determined by the number of thermal expansion vanes in each of the thermal sensing zones 306 and 307 and the temperature of the cooling fluid entering the thermal sensing zones 306, 307 from the heat exchanger element 205. In practice, the number of vanes in each of the thermal sensing zones 306, 307 may be increased in order to provide the necessary amount of force to overcome hydraulic pressures in the valve control zone 308.

The dimensional system of a valve element 205, comprising the length of the vanes 309, 310, 316, 317, the angle α, the offset width β, and the length of the valve control arm 313, itself comprises a temperature-responsive mechanical amplifier 318. The temperature-responsive mechanical amplifier 318 may be adjusted by changes to the family of dimensions of this dimensional system to provide the desired movement of the valve control arm 313 to gradually open and close the valve entry port 133 as the amplifier 318 responds to changes in the temperature of cooling fluid flowing through the first thermal sensing zone 306 and the second thermal sensing zone 307.

It is understood that the position, shape and the size of the valve entry port 133 and the valve control arm 313 determine if the valve entry port 133 is normally closed or normally open at a specific temperature. The valve control arm 313 is movable between a fully closed position through a multiplicity of partially opened conditions to a fully opened condition in response to a preselected range of temperatures of the cooling fluid circulating through the valve element 305. Cooling fluid will circulate when the valve element 305 is in any open condition, meaning partially or fully open. The position, shape and size of the valve entry port 133, in combination with the dimensional system of the temperature-responsive mechanical amplifier 318, also determines the temperature at which the valve entry port 133 begins to open or close and when it becomes fully open or closed. These dimensional considerations are easily understood, are calculable and are not further described here.

A fluid-tight chamber or valve control zone 308 is defined about the valve entry port 133 by vane 309, first horizontal push bar 320, valve control arm 313, second horizontal push bar 321, vane 316, a portion of an outer wall 323 of the valve element 305, an upper surface, such as floor 113 of distribution layer 111 and a lower surface, such as second intermediate layer 109. The fluid-tight valve control zone 308 isolates the cooling fluid in the valve control zone 308 from the cooling fluid in the first thermal sensing zone 306 and the second thermal sensing zone 307 (first thermal sensing zone 306 and second thermal sensing zone 307 being in fluid communication with each other, but not the valve control zone 308). As illustrated in FIG. 3a, the valve control arm 313 does not completely bisect the valve control zone 308, a gap or passage being defined between the end of the valve control arm 313 and the outer wall 323 so that cooling fluid may flow through the gap about the control arm 313 to completely fill the valve control zone 308. To create the fluid-tight valve control zone 308, each of the portions of the valve layer 110 comprising the fluid-tight zone 308, i.e., vane 309, push bar 320, valve control arm 313, push bar 321, vane 316 and outer wall 323, all have a height at all points substantially the same as the height of the valve layer 110, so that each contacts flush with both the floor 113 of the fluid distribution layer 111 and the second intermediate layer 109 to create a fluid-tight seal. Additionally, it is important that at least a part of the portion of the valve control arm 313 within the valve control zone 308 substantially spans the height of the valve layer 110 to touch both the floor 113 above and the layer 109 below so that the valve control arm 313 cannot be pressed open by the pressure of the fluid arising from the heat exchanger layer 108.

In contrast to the elements defining the valve control zone 308, the other vanes 310, 317 of the valve element 118 and the portions of push bars 320, 321 not integral to forming part of the valve control zone 308, do not span the entire height of the valve layer 110, rather such elements 310, 317, 320, 321 have at least some portion having a height less than the height of the valve layer 110 so that fluid may flow about such elements 310, 317, 320, 321 and thus throughout the sensing zones 306, 307, but not the segregated and independent fluid-tight valve control zone 308. The portion of the control arm 313 not within the valve control zone 308 need only allow the flow of fluid between sensing zones 306 and 307, such as by leaving a gap between the end of the arm 313 and the wall of the sensing zones 306 and 307 or by having a height less than the height of the valve layer 110.

A valve element 305 is said to be closed (i.e., the valve is closed or in the closed condition), when the valve control arm 313 completely blocks either or both of the valve entry port 133 and the fluid exit port 124 in the floor 113 of the fluid distribution layer 111 (not shown in FIG. 3a). As illustrated in the embodiment shown in FIG. 3a, the valve entry port 133 and the fluid exit port 124 are substantially aligned with each other. When the valve is closed, fluid is blocked from entering the valve control zone 308 from the associated heat exchanger element 116. Thus, when the valve is closed, the cooling fluid in the valve control zone 308 may have a different temperature from the cooling fluid circulating through the thermal sensing zones 306, 307, which, as illustrated in FIG. 3c, are fed from the always-open vane entry point 327 (item 216 in FIG. 2) which is in fluid communication with the associated heat exchanger element 116. However, when the valve is opened, cooling fluid is permitted to flow from the associated heat exchanger element 116 through valve control zone 308 and to exit the valve control zone 308 through the associated fluid exit port 124 into the return-side fluid exit channel 122 of the fluid distribution layer 111 (shown in FIG. 1). Thus, when the valve is open, the cooling fluid in the valve control zone 308 will have substantially the same temperature as the cooling fluid in the thermal sensing zones 306, 307 because all of the zones 306, 307, 308 are in fluid communication with the associated heat exchanger element 116.

Thus it can be seen that the valve element 118 responds to the temperature of the cooling fluid flowing from the associated heat exchanger element 116.

FIG. 3b illustrates an alternate embodiment of a valve element 305. Unlike in FIG. 3a in which the fluid exit port 124 in the floor 113 of the fluid distribution layer 111 is substantially aligned with the valve entry port 133, the valve exit port 325 of the embodiment shown in FIG. 3b is positioned to provide an unimpeded opening to the valve control zone 308 regardless of the movement of the valve control arm 313. The valve exit port 325 is in constant fluid communication to the overlying fluid distribution layer 111, specifically the return side fluid exit channel 122. In one embodiment, the cooling fluid flow through the valve control zone 308 is controlled by the opening and closing of the cooling fluid entrance port 330 through which the fluid enters the valve control zone 308 when the valve control arm 313 moves to the right in the direction of arrow 314 upon an increase in the temperature of the cooling fluid.

FIG. 3b also illustrates an alternate embodiment for the shape of the cooling fluid entrance port 330. Rather than the valve entry port 133 having a round shape as shown in FIG. 3a, a cooling fluid entrance port 330 may have a substantially triangular shape, with a point 333 of the triangle oriented substantially perpendicular to the nearest side 334 of the valve control arm 313 so that an increasing amount of the cooling fluid entrance port 330 is uncovered or opened as the valve control arm 313 is displaced along arrow 314 due to an increase in temperature of the cooling fluid. Such shaping and orientation of the cooling fluid entrance port 330 allows the rate of cooling fluid flow through the port 330 to increase exponentially as the displacement of the valve control arm 313 increases due to a rise in the temperature of the corresponding thermal zone (not shown) of the electronic component (not shown) which causes the cooling fluid in the associated heat exchanger element (not shown) to rise, bringing additional heat into the first and second thermal sensing zones 306, 307 of the valve element 305, resulting in a correspondingly greater displacement of the valve control arm 313. The flow of cooling fluid into the valve control zone 308 starts slowly and rapidly increases as the temperature increases causing the valve control arm 313 to be displaced to the right in the direction of arrow 314 as the vanes 309, 310, 316, 317 expand. This movement exposes the narrow end of the cooling fluid entrance port 330 first. Further movement opens larger areas of the port 330 until it is fully open.

FIG. 3b further illustrates an additional alternate embodiment of a valve element 305 having a second, separate heating fluid entrance port 331 in fluid communication with the associated heat exchanger element 116. The heating fluid entrance port 331 may be opened by the shifting of the valve control arm 313 when the underlying electronic component 106 is substantially inactive (generating little or no heat), and, therefore, the cooling fluid provided through the sensing circuit to the first and second thermal sensing zones 306, 307 is relatively cooler, causing the vanes 309, 310, 316 and 317, to retract sufficiently to cause the valve control arm 313 to be displaced along arrow 332. This opens the heating fluid entrance port 331 and allows the cooling fluid to circulate through the valve control zone 308 from the underlying heat exchanger layer 108 and to the fluid distribution layer 111. Note that in this embodiment, fluid must be permitted to flow to the valve exit port 325 from the heating fluid entrance port 331 without being blocked by the control arm 313. This may be accomplished either by reducing the height of the control arm 313 about the waist portion 349 so that it does not span the entire height of the valve layer 110 so that fluid may pass across or under the lateral width ω of the waist portion 349, or the length of the arm 313 must extend to cover the valve entry port 333 but not reach the outer wall 323 of the valve control zone 308 as shown in FIG. 3b.

The cooling fluid supplied to the micro-valve 105 associated with an electronic component 106 comes from a common supply for other electronic components 106 within the data center. For an inactive electronic component 106, the cooling fluid supplied to the micro-valve 105 may potentially be at an elevated temperature relative to the temperature of an inactive electronic component, the cooling fluid having gained heat generated by other active and operating electronic components and having reached a system-wide supply-side cooling fluid mean operating temperature higher than the ambient temperature of an inactive electronic component 106. In such case, allowing the cooling fluid to flow through the underlying heat exchanger element 205 in heat exchanger layer 108 through the opening of heating fluid entrance port 331 will serve to warm or increase the temperature of the underlying inactive electronic component 106. Thus, the underlying electronic component 106 may be kept warm and at a “ready to run” temperature. This will reduce the temperature excursion of the electronic component 106 when it becomes inactive and thereby will serve to extend the operating life of the electronic component 106.

If desired, to safeguard against a situation where it is likely that none or very few of the electronic components 106 in the data center are operational and there is no other source of heat to warm the inactive and/or cold electronic components 106, heat can be added to the supply side cooling fluid system by connecting it to an external heat source such as a boiler, thereby warming cooling fluid in the system and thus all of the critical electronic components 106 that are equipped with a proportional micro-valve 105.

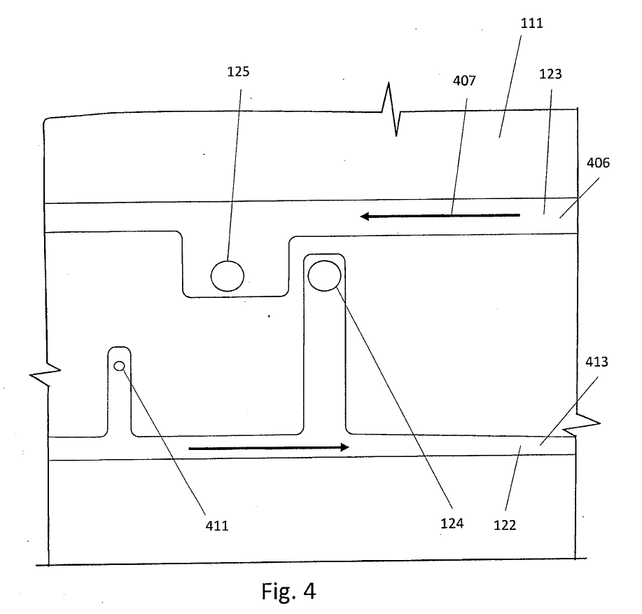

Referring now to FIG. 3c, a valve element 305 comprising a temperature-responsive mechanical amplifier 318, valve control zone 308, first and second thermal sensing zones 306, 307, vane entry port 327, vane exit port 329, a valve control arm 313 and a valve entry port 133 is shown. Cooling fluid flows through the valve control zone 308 when the valve entry port 133 is in a partially or wholly open condition. Cooling fluid passes from the distribution layer 111 (not shown), through the cooling fluid port 315, into the associated heat exchanger element 205 (not shown) and out of the heat exchanger element 205 through the valve entry port 133 into the valve control zone 308 of the valve element 305 and then through the fluid exit port 124 (not shown) of the fluid distribution layer 111 into the fluid exit channel 122 (shown in FIG. 4).

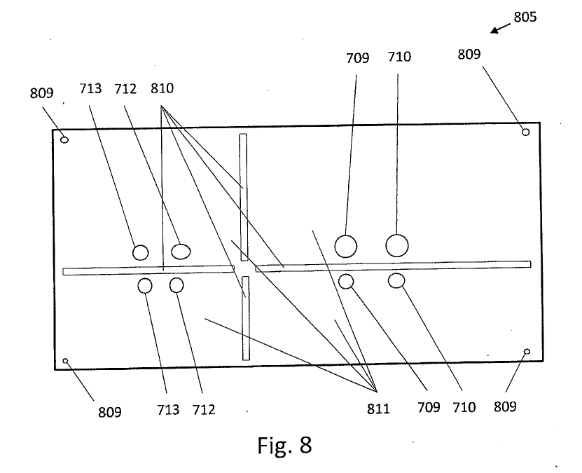

At all times, a fluid sensing circuit carries a small amount of cooling fluid from the fluid distribution layer 111 through the valve layer 110 to the underlying heat exchanger layer 108 and back out through the valve layer 110 to the fluid distribution layer 111 for each cooling subsystem. A fluid sensing circuit comprises, in sequence, incoming fluid distribution header 406 (shown in FIG. 4), fluid entry port 125, cooling fluid port 315 of valve layer 110 (shown in FIG. 3c), heat exchanger element 205 (shown in FIG. 2), sensing exit port (designated 216 in FIG. 2, 809 in FIG. 8, and 327 in FIG. 3c), a thermal sensing zone, preferably comprising first thermal sensing zone 306 and second thermal sensing zone 307, vane exit port (designated 329 in FIG. 3c, and 411 in FIG. 4), and outgoing fluid distribution header 413 (shown in FIG. 4).

Returning to FIG. 2, in the heat exchanger layer 108, the temperature of the cooling fluid is raised to be substantially equal to the temperature of the underlying electronic component 106. As shown in FIG. 3c, in the valve layer 110, the cooling fluid flows through the first thermal sensing zone 306 about vanes 310 and rear portion 335 of push bar 320, and then through the second thermal sensing zone 307 about vanes 317 and rear portion 336 of push bar 321, thereby exposing all of the vanes 309, 310, 316, 317 and push bars 320, 321 of the mechanical amplifier 318 to the temperature of the cooling fluid. The vanes 309, 310, 316, 317 and push bars 320, 321 then expand or contract as dictated by their material and the temperature of the cooling fluid, causing the valve entry port 133 to be opened or closed by the movement of the valve control arm 313 caused by the concomitant displacement of the push bars 320, 321 of the mechanical amplifier 318. Note that cooling fluid flowing through the thermal sensing zones 306, 307 on the valve layer 110 cannot enter the valve control zone 308, because the thermal sensing zones 306, 307 are not in fluid communication with the valve control zone 308 within the valve layer 110.

Preferably, the dimensions of the vanes 310, 317 and rear portions 335, 336 of push bars 320, 321 (i.e., those structures not defining the fluid-tight valve control zone 308) may be varied to create a generally tortured path through which the cooling fluid may travel about such elements to enhance the distribution of fluid more uniformly about such elements. For example and not by way of limitation, the first set of vanes 310 could only have an opening across the top of the vane on one side of the push bar 320, with the next set of vanes 310 only having an opening across the bottom of the vane 310 on the other side of the push bar 320, and so on, so that the cooling fluid would be forced over and under the vanes as it passes through the first thermal sensing zone 306, rather than simply flowing straight under or over all vanes 310 within the first thermal sensing zone 306.

FIG. 4 illustrates a portion of a fluid distribution layer 111 according to the present invention. The elements illustrated in FIG. 4 represent all of the distribution elements that would be associated with a single cooling subsystem. The fluid distribution layer 111 would repeat this set of distribution elements for each cooling subsystem needed for the electronic component 106 being cooled, preferably using a common incoming fluid distribution header 406 and outgoing fluid distribution header 413 for all cooling subsystems of a micro-valve.

The distribution elements for each cooling subsystem comprise an incoming fluid distribution header 406 supplying a fluid entry channel 123 and a fluid exit channel 122 feeding into an outgoing fluid distribution header 413. Incoming fluid distribution header 406 and fluid entry channel 123 provide a fluid connection to the supply side of the data center's cooling fluid system (not shown), and fluid exit channel 122 and outgoing fluid distribution header 413 provide a fluid connection to the return side of the cooling fluid system (not shown). The fluid entry channel 123 comprises a fluid entry port 125 for each cooling subsystem positioned to cool a thermal zone (not shown) of the underlying electronic component 106. The fluid exit channel 122 comprises a fluid exit port 124 and a vane exit port 411 for each cooling subsystem of the micro valve.

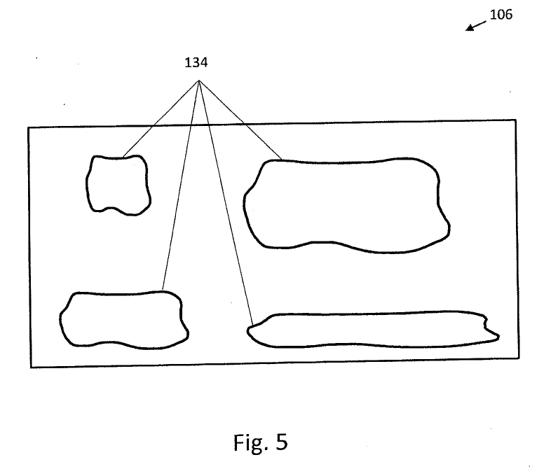

FIG. 5 is a schematic representation of a thermal map of an electronic component 106. The thermal map illustrated shows one or more hot thermal zones 134 of varying size and shape. For an electronic component having a thermal map as shown in FIG. 5, a micro-valve of the present invention (not shown) would typically be segmented into four cooling subsystems to support four heat exchanger elements, preferably one to be associated with each hot thermal zone 134. Other electronic components will have a variety of different thermal maps which, in turn, will require micro-valves having corresponding segmentation.

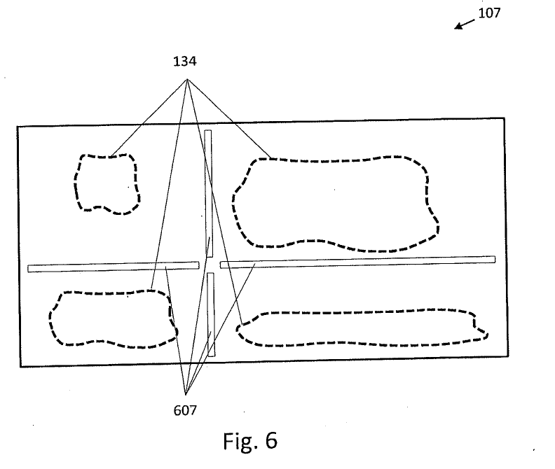

FIG. 6 is a top view of a first intermediate layer 107 according to the present invention illustrating how the divisions or segments of the first intermediate layer may be structured to correspond with the pattern of hot thermal zones 134 of an underlying electronic component, such as electronic component 106 of FIG. 5. The first intermediate layer 107 is segmented with thermal breaks 607 comprising slots cut into, preferably entirely through, the material of the layer 107 to form divisions or segments having a size and shape which generally corresponds to the size and shape of the thermal zones 134 of the electronic component 106 so that targeted cooling can be applied independently to each thermal zone 134 by a correspondingly shaped cooling subsystem including an associated heat exchanger element (not shown in FIG. 6) and valve element (not shown in FIG. 6). In a preferred embodiment, thermal breaks in all layers of the device (except the distribution layer) separate or insulate each of the cooling subsystems within the micro-valve 105.

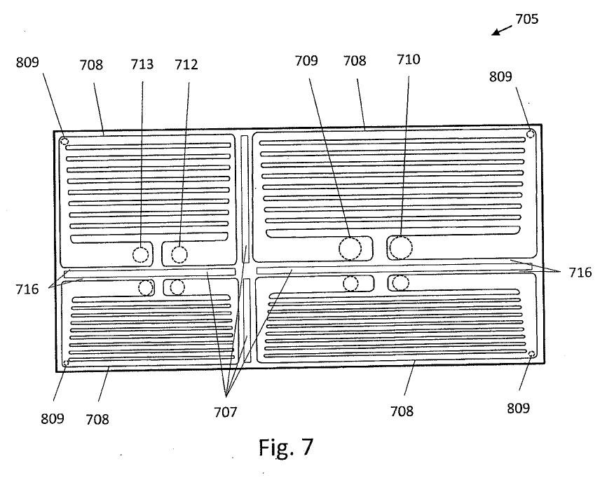

FIG. 7 is an illustration of a heat exchanger layer 705 having one or more, in this case four (4), heat exchanger elements 708, one each for association with a thermal zone 134 of the underlying electronic component 106 of FIG. 5. The heat exchanger elements 708 are arranged in the same pattern as the underlying first intermediate layer 107 (shown in FIG. 6). The heat exchanger layer 705 is also subdivided into a corresponding number of substantially independent thermal segments 716 by thermal breaks 707. Thermal breaks 707 act as an impediment to heat transfer between thermal segments 716, such as being slots cut into or preferably through the heat exchanger layer 705, or comprising a material which is a poor thermal conductor.

As illustrated in FIGS. 7 and 5, the largest heat exchanger elements 708 having the largest dimensions will heat and cool a correspondingly larger thermal zone 134. Should a particular thermal zone 134 generate a larger thermal load needing to be dissipated, then such heat exchanger elements 708 may be fed by correspondingly larger cooling fluid entry ports 709 and correspondingly larger fluid return ports 710 to circulate relatively greater amounts of cooling fluid to meet the demand for cooling. Using the same logic, a smaller thermal zone 134 or one generating relatively less heat underlying a heat exchanger element 708 may not require a large volume of cooling fluid to dissipate the generated heat and can be designed with a relatively smaller cooling fluid entry port 712 and smaller fluid return port 713 to limit the flow of cooling fluid. By proportionally sizing the heat exchanger elements and the fluid entry and exit ports to match the anticipated thermal load in each zone, regardless of physical size, the flow rate, the temperature increase and the pressure drop across the heat exchanger element 708 may be configured at the time of manufacturing to desirably match the characteristics of different thermal zones 134 of different kinds of electronic components 106.

As shown in FIG. 7, each heat exchanger element 708 has an associated sensing exit port 809 for creating the sensing circuit.

FIG. 8 is an illustration of a second intermediate layer 805 defining the fluid entry ports 709, 712, fluid return ports 710, 713, and sensing exit ports 809 between the underlying heat exchanger elements 708 and the overlying valve elements 118. As discussed with regard to FIG. 7, ports 709, 712, 710 and 713 may be sized differently depending upon the volume of cooling fluid required to flow through the cooling subsystem in order to provide adequate cooling.

FIG. 8 also illustrates the use of thermal breaks 810 in the second intermediate layer 805 to create two or more distinct thermal zones 811 for each cooling subsystem, each thermal zone 811 corresponding to a heat exchanger element 708 in the underlying heat exchanger layer 705. The use of thermal breaks 810 would not be necessary where there is only a single thermal zone 134 underlying the second intermediate layer 805.

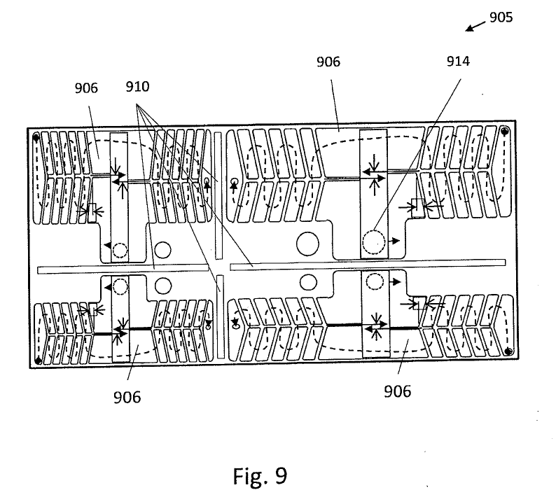

FIG. 9 illustrates a valve layer 905 having one or more, in this case four (4), valve elements 906 shaped to correspond to the thermal zones 134 of an underlying electronic component 106, in this case, the electronic component 106 of FIG. 5. Like in the second intermediate layer 805 above, the valve elements 906 of each cooling subsystem are separated from adjoining valve elements 906 by thermal breaks 910 in the valve layer 905.

FIG. 10 illustrates a fluid distribution layer 111 according to the present invention which would carry cooling fluid to and from all of the cooling subsystems necessary to cool the electronic component 106 shown in FIG. 5. This embodiment of the fluid distribution layer 1005 defines one or more, in this case four (4), main fluid entry ports 1007 to transmit the cooling fluid from the incoming distribution header 1006 to the underlying valve layer 905 (not shown), one or more, in this case four (4), main fluid exit ports 1008, returning the fluid to the output header 1011, and one or more, in this case four (4), sensing exit ports 1010 for returning cooling fluid from the thermal sensing zones 306, 307 of the fluid sensing circuit of each cooling subsystem.

In another embodiment of the present invention not illustrated in the figures, the control arm of the valve element may be designed to block or otherwise control the input flow of cooling fluid from the incoming fluid distribution header of the fluid distribution layer to the heat exchanger, rather than on the return side from the heat exchanger back to the outgoing fluid distribution header of the fluid distribution layer. In such a case, in order to enable a continuously flowing sensing circuit, a separate physical path or opening of unimpeded fluid flow from the incoming fluid distribution header, through the intermediate valve layer and first and second intermediate layers to each heat exchanger must be provided in order to provide continuous feedback through the thermal sensing zone of the valve element. Likewise, in such an alternate embodiment, a direct return path from the heat exchanger to the fluid distribution layer would be required.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

I claim:

1. A proportional micro-valve for regulating the temperature of an electronic component of the type having one or more thermal zones comprising:
(a) a cooling subsystem associated with each of said thermal zones;
(b) an incoming fluid distribution header for supplying cooling fluid to said cooling subsystems;
(c) an outgoing fluid distribution header for carrying cooling fluid away from said cooling subsystems;
(d) wherein each cooling subsystem comprises a cooling circuit for carrying cooling fluid between the incoming fluid distribution header and the outgoing fluid distribution header, said cooling circuit comprising, in fluid communication:
(i) a valve control zone of a valve element, said valve element movable between a closed position, through a multiplicity of partially open conditions, to a fully open condition; and
(ii) a liquid cooling means through which cooling fluid flows when said valve element is in any open condition;
(e) wherein each cooling subsystem further comprises a fluid sensing circuit for carrying cooling fluid substantially continuously between the incoming fluid distribution header and the outgoing fluid distribution header, said fluid sensing circuit comprising, in fluid communication:
(i) said liquid cooling means; and
(ii) a thermal sensing zone of said valve element, said thermal sensing zone having a temperature-responsive mechanical amplifier for moving the valve element between the closed position and the fully open condition.

2. The proportional micro-valve of claim 1 wherein said mechanical amplifier further comprises a plurality of thermal expansion vanes within said thermal sensing zone, said plurality of thermal expansion vanes connected to a valve control arm extending into the valve control zone and being displaceable to move said valve element between the closed position, through said multiplicity of partially open conditions, to the fully open condition.

3. The proportional micro-valve of claim 2 wherein said plurality of thermal expansion vanes are connected to a push bar within said thermal sensing zone, said push bar further connected to the valve control arm.

4. The proportional micro-valve of claim 1 wherein said thermal sensing zone comprises a first thermal sensing zone in fluid connection with a second thermal sensing zone, and wherein said mechanical amplifier further comprises:
(f) a first plurality of thermal expansion vanes within said first thermal sensing zone, said first plurality of thermal expansion vanes connected to a first push bar within said first thermal sensing zone, said first push bar connected at a first point to a first side of a valve control arm, said valve control arm having an end extending into the valve control zone and being displaceable to move said valve element between the closed position, through a multiplicity of partially open conditions, to the fully open condition;
(g) a second plurality of thermal expansion vanes within said second thermal sensing zone, said second plurality of thermal expansion vanes connected to a second push bar within said second thermal sensing zone, said second push bar connected to a second side of the valve control arm at a second point, said second point being horizontally offset along the valve control arm to the first point;
(h) said first plurality of thermal expansion vanes configured to expand primarily lengthwise towards the valve control arm in response to an increase in the temperature of the cooling fluid circulating through said fluid sensing circuit; and
(i) said second plurality of thermal expansion vanes configured to expand primarily lengthwise towards the valve control arm in response to an increase in the temperature of the cooling fluid circulating through said fluid sensing circuit.

5. The proportional micro-valve of claim 1 wherein said cooling subsystems are separated within the micro-valve by thermal breaks.

6. The proportional micro-valve of claim 1 wherein said cooling means comprises a fluid heat exchanger.

7. The proportional micro-valve of claim 1 wherein said temperature-responsive mechanical amplifier moves the valve element from the closed position, through the multiplicity of partially open conditions, to the fully open condition in response to a preselected range of temperatures of cooling fluid circulating through said valve element.

8. The proportional micro-valve of claim 1 wherein said fluid sensing circuit comprises a means for warming an inactive electronic component.

9. A proportional micro-valve for regulating the temperature of an electronic component of the type having one or more thermal zones comprising:
(a) a heat exchanger layer for affixing proximate the electronic component;
(b) a fluid distribution layer;
(c) a valve layer positioned intermediate the heat exchanger layer and the fluid distribution layer;
(d) said heat exchanger layer having one or more heat exchanger elements, each of such heat exchanger elements associated with one of said thermal zones of the electronic component, each of said heat exchanger elements having, in fluid communication, a fluid entrance header, a plurality of main cooling channels and an exit channel header;
(e) said fluid distribution layer having an incoming fluid distribution header and an outgoing fluid distribution header, said incoming fluid distribution header in fluid communication with each of said heat exchanger elements;
(f) said valve layer having one or more valve elements, each of such valve elements associated with one of the heat exchanger elements of said heat exchanger layer, each of said valve elements having:
(i) a fluid-tight valve control zone in fluid communication with the associated heat exchanger element and the outgoing fluid distribution header;
(ii) a thermal sensing zone, said thermal sensing zone having a temperature-responsive mechanical amplifier for moving a valve control arm, said valve control arm extending from said thermal sensing zone into said fluid-tight valve control zone and being positionable between a fully closed position for preventing fluid communication between the associated heat exchanger element and outgoing fluid distribution header via the valve control zone, and a fully open condition for allowing fluid communication between the associated heat exchanger element and outgoing fluid distribution header via the valve control zone;
(iii) a valve port for allowing fluid communication between the incoming fluid distribution header and the associated heat exchanger element;
(iv) a sensing entry port for allowing fluid communication between the associated heat exchanger element and the thermal sensing zone; and
(v) a sensing exit port for allowing fluid communication between the thermal sensing zone of the associated valve element and the outgoing fluid distribution header.

10. The proportional micro-valve of claim 9 wherein said mechanical amplifier further comprises a plurality of thermal expansion vanes within said thermal sensing zone, said plurality of thermal expansion vanes connected to said valve control arm.

11. The proportional micro-valve of claim 10 wherein said plurality of thermal expansion vanes are connected to a push bar within said thermal sensing zone, said push bar further connected to the valve control arm.

12. The proportional micro-valve of claim 9 wherein said thermal sensing zone comprises a first thermal sensing zone in fluid connection with a second thermal sensing zone, and wherein said mechanical amplifier further comprises:
(a) a first plurality of thermal expansion vanes within said first thermal sensing zone, said first plurality of thermal expansion vanes connected to a first push bar within said first thermal sensing zone, said first push bar connected at a first point to a first side of the valve control arm;
(b) a second plurality of thermal expansion vanes within said second thermal sensing zone, said second plurality of thermal expansion vanes connected to a second push bar within said second thermal sensing zone, said second push bar connected to a second side of the valve control arm at a second point, said second point being horizontally offset along the valve control arm to the first point;
(c) said first plurality of thermal expansion vanes configured to expand primarily lengthwise towards the valve control arm in response to an increase in the temperature of the cooling fluid circulating through said fluid sensing circuit; and
(d) said second plurality of thermal expansion vanes configured to expand primarily lengthwise towards the valve control arm in response to an increase in the temperature of the cooling fluid circulating through said fluid sensing circuit.

13. The proportional micro-valve of claim 9 wherein the heat exchanger elements are separated within the heat exchanger layer by thermal breaks.

14. The proportional micro-valve of claim 9 wherein the valve elements are separated within the valve layer by thermal breaks.

15. The proportional micro-valve of claim 9 further comprising a first intermediate layer disposed between the electronic component and the heat exchanger layer.

16. The proportional micro-valve of claim 15 wherein said first intermediate layer further comprises one or more thermal breaks dividing said first intermediate layer into one or more segments, each of such segments associated with one of said thermal zones of the electronic component.

17. The proportional micro-valve of claim 9 further comprising a second intermediate layer disposed between the valve layer and the heat exchanger layer, said second intermediate layer defining:
(a) one or more cooling fluid entry ports for allowing fluid communication between the valve port of each valve element of the valve layer and the associated heat exchanger element of the heat exchanger layer;
(b) one or more cooling fluid exit ports for allowing fluid communication between the each heat exchanger element of the heat exchanger layer and the valve control zone of the associated valve element of the valve layer; and
(c) one or more sensing exit ports for allowing fluid communication between each heat exchanger element of the heat exchanger layer and the thermal sensing zone of the associated valve element of the valve layer.

18. The proportional micro-valve of claim 17 wherein said second intermediate layer further comprises one or more thermal breaks dividing said second intermediate layer into one or more segments, each of such segments associated with one of said heat exchanger elements of the heat exchanger layer.

19. The proportional micro-valve of claim 9 wherein a substantially continuous flow of cooling fluid through a fluid sensing circuit associated with each of said thermal zones comprises a means for warming an inactive electronic component, wherein each of said fluid sensing circuits comprises incoming fluid distribution header, the heat exchanger element associated with one of said thermal zones, the thermal sensing zone associated with such thermal zone, and the outgoing fluid distribution header.
